(19) United States
(12) Patent Application Publication
(10) Pub. No.: US 2016/0004004 A1
(43) Pub. Date: Jan. 7, 2016

(54) ELECTRONIC READING DEVICE AND OPERATING METHOD FOR THE SAME

(71) Applicant: E INK HOLDINGS INC., Hsinchu (TW)

(72) Inventors: Yu-Nan PAO, Hsinchu County (TW); Hsin-Tao HUANG, Hsinchu County (TW); Tsai-Wei SHEI, Hsinchu City (TW); Chih-Ching YIEN, Taoyuan County (TW)

(73) Assignee: E INK HOLDINGS INC., Hsinchu (TW)

(21) Appl. No.: 14/612,296

(22) Filed: Feb. 3, 2015

(30) Foreign Application Priority Data
Jul. 7, 2014 (TW) 103123279

(51) Int. Cl. F21V 8/00

(52) U.S. Cl. CPC G02B 6/0068; G02B 6/0055

(57) ABSTRACT

An electronic reading device and an operating method for the same are disclosed. The electronic reading device includes a front light module and a reflective display. The front light module includes a white light source and a color light source. The color light source is selected from a group consisting of a red light source, a green light source and a blue light source. The reflective display is disposed on a side of the front light module.

This application claims the benefit of Taiwan application Serial No. 103123279, filed Jul. 7, 2014, the subject matter of which is incorporated herein by reference.

### BACKGROUND OF THE INVENTION

1. Field of the Invention

The invention relates in general to an electronic reading device and an operating method for the same, and more particularly to a reflective electronic reading device and an operating method for the same.

2. Description of the Related Art

In recent years, the industries are proactively engaged in the development of technology in electronic display device such as electrophoretic display device. When displaying a frame the electrophoretic display device can achieve certain level of blackness and whiteness apart from the features of lightweight, thinness and portability. Therefore, when the user uses the electrophoretic display device for reading, the user can enjoy the feeling as if he/she were reading an actual book. However, the black and white display frame lacks variety, and easily makes the user feel monotonous and have less fun in reading.

### SUMMARY OF THE INVENTION

According to one embodiment of the present invention, an electronic reading device is disclosed. The electronic reading device comprises a front light module and a reflective display. The front light module comprises a white light source and a color light source. The color light source is selected from a group consisting of a red light source, a green light source and a blue light source. The reflective display is disposed on a side of the front light module.

According to another embodiment of the invention, an operating method for an electronic reading device is disclosed. The electronic reading device comprises a front light module and a reflective display. The front light module comprises a white light source and a color light source. The color light source is selected from a group consisting of a red light source, a green light source and a blue light source. The reflective display is disposed on a side of the front light module. The operating method comprises controlling the luminescent state of the white light source and the color light source to modulate the background color of the electronic reading device.

The above and other aspects of the invention will become better understood with regard to the following detailed description of the preferred but non-limiting embodiment (s). The following description is made with reference to the accompanying drawings.

### BRIEF DESCRIPTION OF THE DRAWINGS

FIG. 1 is a cross-sectional view of an electronic reading device according to an embodiment of the invention.

FIG. 2 is a top view of a front light module according to an embodiment of the invention.

### DETAILED DESCRIPTION OF THE INVENTION

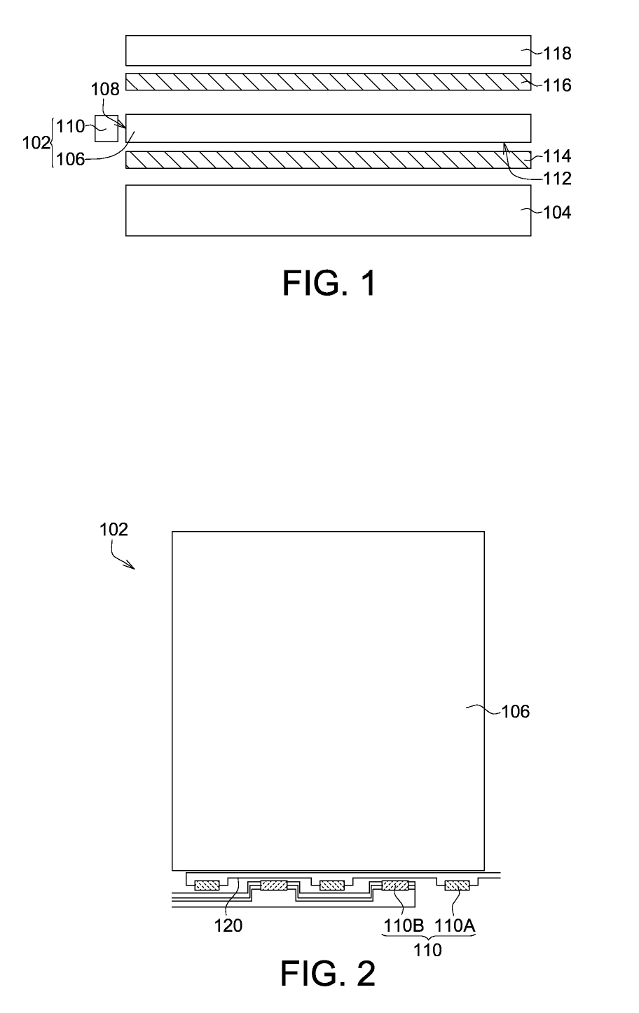

FIG. 1 is a cross-sectional view of an electronic reading device according to an embodiment of the invention. The electronic reading device comprises a front light module 102 and a reflective display 104. The front light module 102 comprises a light guide plate 106 and a light source 110 adjacent to a light incoming surface 108 of the light guide plate 106. The reflective display 104 is disposed adjacent to a light outputting surface 112 of the light guide plate 106. The reflective display 104 can be realized by a liquid crystal display (LCD) or an electrophoretic display (EPD), but the invention is not limited thereto. Examples of the reflective display comprise black and white display. Examples of the electrophoretic display comprise micro-cup electrophoretic display panel or micro-capsule electrophoretic display panel. The electrophoretic display panel can only show black color, white color and pure gray scales. The light guide plate 106 can have micro-structures disposed on the surface, such as a uniformly distributed course surface, via which the light coming from point light sources can be converted into a uniformly distributed surface light source. The light guide plate 106 can be formed with a material permeable to the light such as polymethyl methacrylate (PMMA) and polycarbonate (PC).

The adhesive layer 114 can be disposed between the front light module 102 and the reflective display 104 in a direct or indirect manner. The adhesive layer 116 can be disposed between the protection sheet 118 and the light guide plate 106 in a direct or indirect manner. Based on actual needs and product design, some optical films not illustrated in the diagram can be disposed between the reflective display 104 and the protection sheet 118.

FIG. 2 is a top view of a front light module 102 according to an embodiment of the invention. The light source 110 adjacent to the light guide plate 106 may comprises LED light bars such as but not limited to the white light source 110A and the color light source 110B. The color light source 110B is selected from a group consisting of a red light source, a green light source and a blue light source. LED has the advantages of low cost, ready availability and excellent luminous efficiency. In an embodiment, the color light source 110B comprises RGB chips in the LED structure of a packaging unit. The red chip emits a light with principal wavelength of 600 nm˜700 nm. The green chip emits a light with principal wavelength of 500 nm˜600 nm. The blue light chip emits a light with principal wavelength of 380 nm˜500 nm. In the present specification, “principal wavelength” refers to the wavelength with largest intensity of the light spectrum. In some embodiments, the light source 110 can be realized by laser or other suitable illuminants.

The white light source 110A and the RGB light sources of the color light source 110B are electrically connected to a controller (not illustrated in the diagram) through respective conductive loops 120. In some embodiments, the conductive loops 120 can be designed as suitable circuits in response to actual needs.

The operating method for an electronic reading device comprises controlling the luminescent state of the white light source 110A and the color light source 110B, such as brightness, chromaticity and color temperature, to modulate the background light of the electronic reading device. For example, through four independent conductive loops 120, the controllers of brightness, chromaticity and color temperature modulate the luminescent state of the light sources with the input power provided to the white light source 110A and the RGB light sources. For example, the background brightness is mainly provided by the white light source 110A, and the background colors are determined by the RGB light sources of the color light source 110B and can be modulated to a diversity of dark or light colors such as blue, green red, yellow and purple. Since the light source of each color is controlled by an independent conductive loop 120 respectively, the electronic reading device can be effectively controlled to an expected background light, that is, a power saving mode, regardless of the differences between the light sources of different colors, such as the differences in the number of light emitting units or the decay rate of light emitting materials.

The background light of the electronic reading device can be adapted to the surroundings, user preferences or situational factors of reading. For example, when the user is reading in a bright surrounding, lower power is provided to the white light source 110A to save power consumption. When the user is reading in a dark surrounding, higher power is provided to the white light source 110A such that the background brightness of the electronic reading device allows the user to read clearly. When the user is reading something thrilling, the user can control the color light source 110B to adjust the background color into light blue or light green to create a thrilling, nervous and mysterious atmosphere. When the user is reading something interesting and enjoyable, the user can control the color light source 110B to adjust the background color into light red or light orange to create a warm and lively atmosphere. Such adjustments provide more funs of reading to the user.

According to the embodiments of the invention disclosed above, the electronic reading device allows the user to adjust the background light to a desired color or achieves a desired effect of reading situation through reading software, so as to provide the user with more versatile effects and enjoy more fun in reading.

While the invention has been described by way of example and in terms of the preferred embodiment (s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. An electronic reading device, comprising:
a front light module comprising a white light source and a color light source, wherein the color light source is selected from a group consisting of a red light source, a green light source and a blue light source; and
a reflective display disposed on a side of the front light module.

2. The electronic reading device according to claim 1, further comprising a plurality of conductive loops electrically connecting the white light source and the color light source respectively.

3. The electronic reading device according to claim 1, wherein the white light source and the color light source comprise light emitting diodes (LEDs), and the reflective display comprises an electrophoretic display.

4. The electronic reading device according to claim 1, wherein the front light module further comprises a light guide plate, the white light source and the color light source are adjacent to a light incoming surface of the light guide plate, and the reflective display is adjacent to a light outputting surface of the light guide plate.

5. The electronic reading device according to claim 1, wherein the reflective display comprises a black and white display.

6. The electronic reading device according to claim 1, further comprising an adhesive layer disposed between the front light module and the reflective display.

7. The electronic reading device according to claim 1, further comprising a protection sheet and an adhesive layer disposed between the protection sheet and the light guide plate.

8. An operating method for an electronic reading device, wherein the electronic reading device comprises:
a front light module comprising a white light source and a color light source, wherein the color light source is selected from a group consisting of a red light source, a green light source and a blue light source; and
a reflective display disposed on a side of the front light module,
wherein the operating method comprises: controlling a luminescent state of the white light source and the color light source to modulate a background color of the electronic reading device.

9. The operating method for an electronic reading device according to claim 8, comprising:
controlling the luminescent state of the white light source and the color light source respectively by using an independent conductive loop.

10. The operating method for an electronic reading device according to claim 8, comprising:
controlling the luminescent state of the white light source and the color light source with input power provided to the white light source and the color light source.
